(19) United States
(12) Patent Application Publication
(10) Pub. No.: US 2019/0019228 A1
(43) Pub. Date: Jan. 17, 2019

(54) IN-STORE CUSTOMER TRACKING AND ENGAGEMENT SYSTEM

(71) Applicant: Capillary Technologies International Pte Ltd., Singapore (SG)

(72) Inventors: Boddu Aneesh REDDY, Bengaluru (IN); Mahadar Rohan ANIL, Bengaluru (IN); Panda Subrat KUMAR, Bengaluru (IN); Banerjee SUMANDEEP, Bengaluru (IN)

(73) Assignee: Capillary Technologies International Pte Ltd., Singapore (SG)

(21) Appl. No.: 16/032,330

(22) Filed: Jul. 11, 2018

(30) Foreign Application Priority Data
Jul. 14, 2017 (IN) 201741025028

(51) Int. Cl. G06Q 30/02; H04W 4/14; H04W 4/80

(52) U.S. Cl. CPC G06Q 30/0281; G06Q 30/0271; H04W 4/80; G06Q 30/0224; H04W 4/14; G06Q 30/0255

(57) ABSTRACT

An instore customer tracking and engagement system for tracking customers in a retail store is provided. The system includes a memory having computer-readable instructions stored therein. The system further includes a processor configured to access customer identification data of one or more customers visiting a retail store. The processor is further configured to determine a unique customer identity signature (UCIS) of each of the one or more customers based upon the customer identification data of the respective customer. In addition, the processor is configured to track the activity of each of the customers within the retail store using the unique customer identity signature of the respective customer. Further, the processor is configured to generate an offline clickstream for each of the one or more customers using the unique customer identity signature as the respective customer moves across the retail store. The system includes a data analytics cloud platform communicatively coupled to processor. The data analytics cloud platform is configured to analyze the offline clickstream of each of the one or more customers and to generate one or more of customer engagement and retail insights. The system further includes a personalized engagement module communicatively coupled to the data analytics cloud platform and configured to facilitate direct and/or in-direct engagement with the customers based upon the customer engagement and retail insights.

### PRIORITY STATEMENT

The present application claims priority under 35 U.S.C. § 119 to Indian patent application number 201741025028 filed 14 Jul. 2017, the entire contents of which are hereby incorporated herein by reference.

### FIELD

At least one example embodiment is generally directed to identification and tracking of customers in a retail environment and more particularly to a system for tracking customers in a retail facility and facilitating customer engagement.

### BACKGROUND

The invention is generally directed to customer identification and more particularly to a system for tracking customers in a facility such as a retail store using a unique customer identification and thereby facilitating real time customer engagement using the unique customer identification.

In the past, businesses relied solely on surveys to understand customer behavior. With recent advancements in e-commerce technologies, efforts are being made to understand the customer behavior/activities in real time as a customer navigates through a retail facility. Some retail stores use a footfall counter to track the footfall of customers in the store. However, such counters have issues with accuracy and uptime during internet fluctuations.

Online retail portals have the ability to track the consumer's activities and behavior for determining insightful analytics. Customer accounts, cookies, web beacons and tracking pixels are some of the tools used for consumer tracking in e-commerce portals. However, there is still a gap between online and offline channels in tracking and understanding the actual behavior of the customers.

Understanding customer behavior in an offline in-store retail may uncover interesting insights, provide direction in areas such as store design, layout and navigation as well as communications and staff interaction. In addition, such retail store analytics may facilitate an engaging store environment that enhances the in-store experience for customers.

Recently, some techniques have been used to perform retail store analytics for offline retail stores based on data collected from customers. However, there is a need for an effective and accurate analytics system that could analyze individual shopper/customer behavior and aggregate such customer data across many retail stores to deliver valuable insights such as footfall of customers, conversion rates, among others of a retail enterprise.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide an in-store customer tracking and engagement system.

Briefly, according to an example embodiment, an instore customer tracking and engagement system is provided. The system includes a memory having computer-readable instructions stored therein. The system further includes a processor configured to access customer identification data of one or more customers visiting a retail store. The processor is further configured to determine a unique customer identity signature (UCIS) of each of the one or more customers based upon the customer identification data of the respective customer. In addition, the processor is configured to track the activity of each of the customers within the retail store using the unique customer identity signature of the respective customer. Further, the processor is configured to generate an offline clickstream for each of the one or more customers using the unique customer identity signature as the respective customer moves across the retail store. The system includes a data analytics cloud platform communicatively coupled to processor. The data analytics cloud platform is configured to analyze the offline clickstream of each of the one or more customers and to generate one or more of customer engagement and retail insights. The system further includes a personalized engagement module communicatively coupled to the data analytics cloud platform and configured to facilitate direct and/or in-direct engagement with the customers based upon the customer engagement and retail insights.

According to another example embodiment, a computer-implemented method for tracking and engaging with the customers is provided. The method includes accessing customer identification data of one or more customers visiting a retail store. The method further includes determining a unique customer identity signature (UCIS) of each of the one or more customers. The UCIS is based upon the customer identification data of the respective customer. In addition, the method includes tracking the activity of each of the customers within the retail store using the unique customer identity signature (UCIS) of the respective customer. Further, the method includes generating an offline clickstream for each of the one or more customers using the unique customer identity signature (UCIS) as the respective customer moves across the store. Furthermore, the method includes analyzing the offline clickstream of each of the one or more customers and generating one or more of customer engagement and retail insights for facilitating direct and/or in-direct engagement with the customers.

According to yet another embodiment, an instore customer tracking and engagement system is provided. The system includes a memory having computer-readable instructions stored therein. The system further includes a processor configured to access customer identification data of one or more customers visiting a retail store. The processor is configured to generate a unique customer detection signature (UCDS) for each of the one or more customers as the customer enters the retail store. The processor is further configured to determine if a unique customer identity signature (UCIS) is associated with each of the one or more customer and generate the unique customer identity signature (UCIS) for the customers visiting the retail store for the first time. The unique customer identity signature (UCIS) is a function of the attributes of the customer and the location of customer within the retail store and time. In addition, the processor is configured to track the activity of each of the customers within the retail store using the unique customer identity signature (UCIS) of the respective customer. The activity includes at least one of customer-to-customer and customer-to-product interactions. Moreover, the processor is configured to generate an offline clickstream for each of the one or more customers using the unique customer identity signature as the respective customer moves across the retail store. The system further includes a data analytics cloud platform communicatively coupled to processor. The data analytics cloud platform is configured to analyze the offline clickstream of each of the one or more customers and to generate one or more of customer engagement and retail insights.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an in-store customer tracking and engagement system for tracking customers in a retail store, according to the aspects of the present invention;

FIG. 2 is a flow chart illustrating a process for identification and tracking customers and their behavior in a retail store using the instore customer tracking and engagement system of FIG. 1, according to aspects of the present invention;

FIG. 3 illustrates example real-time messages sent to customers and store managers of a retail store using the system of FIG. 1, implemented according to the aspects of the present technique;

FIG. 4 is an example foot fall map illustrating footfall of customers in a store generated using the system of FIG. 1, implemented according to the aspects of the present technique;

FIG. 5 illustrates a block diagram illustrating generation of personalized recommendations using the data analytics cloud platform of the system of FIG. 1; and

FIG. 6 is a block diagram of an embodiment of a computing device that is arranged for implementing the in-store customer tracking and engagement system for tracking customers in a retail store, in accordance with at least some embodiments of the present disclosure.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled”. Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions, which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher-level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to customer identification and tracking in a retail environment and more particularly to a system for tracking customers in a retail facility, providing analysis of offline user activity of customers within the retail store and facilitating customer engagement.

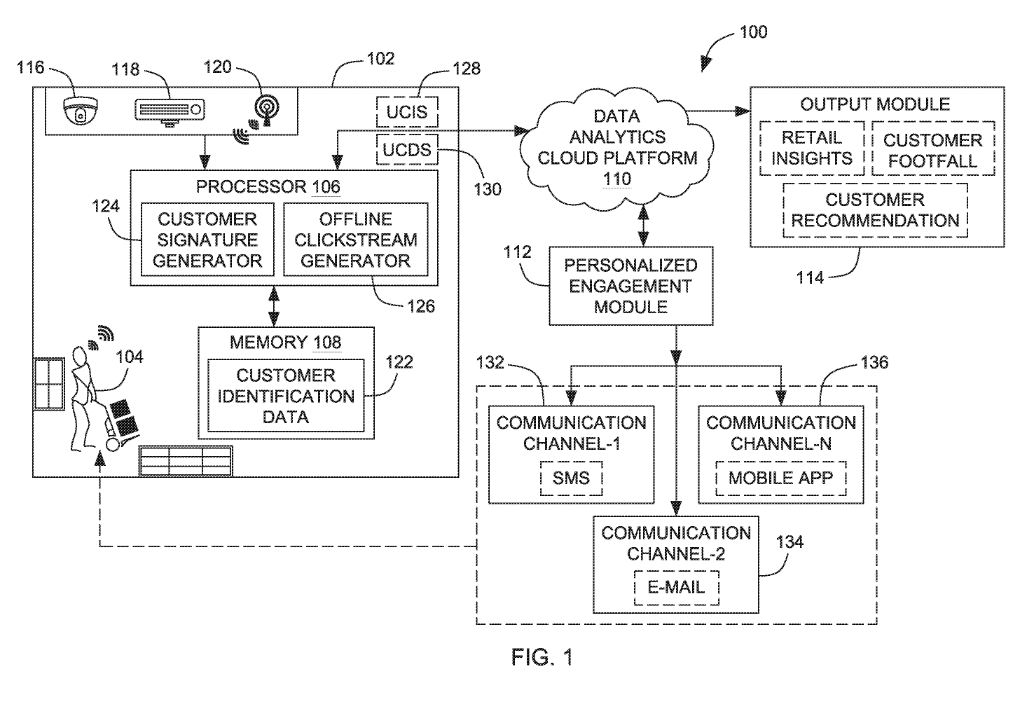

FIG. 1 is a block diagram illustrating an in-store customer tracking and engagement system 100 for tracking customers within a retail store 102. The in-store customer tracking and engagement system 100 is configured to detect and track activities of one or more customers such as represented by reference numeral 104 as they navigate across the retail store 102 and to facilitate engagement of such customers 104. The system 100 includes a, a processor 106, a memory 108, a data analytics cloud platform 110, a personalized engagement module 112, and an output module 114. The system 100 further includes one or more sensors such as generally represented by reference numerals 116, 118 and 120 installed at various locations within the retail store 102.

The processor 106 is configured to access customer identification data 122 of the one or more customers 104 visiting the retail store 102. In this example, the customer identification data 122 may be stored in the memory 106. In an embodiment, the customer identification data 122 may include a mobile number, a photograph, social media information, mobile app information, or combinations thereof of each of the one or more customers 104. In one embodiment, the customer identification data 122 is used to determine demographics, colour of the clothes, pattern of clothes, visual attributes, or combinations thereof of each customer (e.g., 104).

Alternatively, the processor 106 may receive the customer identification data 122 directly from the one or more sensors (e.g., 116, 118 and 120) located at various locations within the retail store 102. In this embodiment, the sensors (e.g., 116, 118 and 120) are configured to detect presence of one or more customers 104 and obtain the customer identification data 122 of each of the one or more customers 104 visiting the retail store 102. The sensors (e.g., 116, 118 and 120) may include sensing devices such as a visible light camera, an infrared or a thermal sensor, a pressure sensor, a microphone, an antenna, or combinations of. The sensor inputs indicative of the customer identification data 122 may include wireless signals like Wi-Fi, NFC and Bluetooth signals. In one embodiment, one or more sensor input may be used to identify the customer 104 entering the retail store 102 and tracking the activity of the customer 104 as he/she navigates through the retail store 112. In some examples, a plurality of sensors (e.g., 116, 118 and 120) may be used for specific identification and tracking of the customer 104. Such sensors (e.g., 116, 118 and 120) may be communicatively coupled to each other for facilitating spatial triangulation and accurately detecting and tracking the customer (e.g. 104).

The processor 106 further includes a customer signature generator 124 and an offline clickstream generator 126. The customer signature generator 124 is configured to determine a unique customer identity signature (UCIS) 128 of each of the one or more customers 104 based upon the customer identification data 122 of the respective customer (e.g., 104). In one embodiment, a unique signature or pattern such as a unique customer detection signature (UCDS) 130 is generated for each customer (e.g., 104) as the customer 104 enters the retail store 102. Further, spatial and temporal coordinates along with other attributes such as color or pattern of the clothes, demographics visual attributes and the like, associated with each customer (e.g., 104), are used to generate the UCIS 128. In an embodiment, once the customer 104 enters the retail store 102, the UCIS 128 is generated and assigned to customer (e.g., 104) and is used to track the customer activity across the retail store 102. The unique customer identity signature (UCIS) 128 assigned to the customer (e.g., 104) may be generated in accordance with the relationship:

UCIS=f(unique attributes of the customer,location,time) Equation 1

wherein the unique customer identity signature (UCIS) 128 is a function of the attributes of the customer (e.g., 104), the location of customer (e.g., 104) within the retail store 102 and time.

It should be noted that the unique customer identity signature (UCIS) 128 facilitates tracking of the customer 104 across multiple sensors (e.g., 116, 118 and 120) located in the retail store 102. It should be noted that each of the sensors (e.g., 116, 118 and 120) may have a limited field of detection and accordingly there may be more than one sensors setups installed throughout the store 102. The system 100 is configured to identify each of the customers 104 based on the UCIS 128 and tracks the customers 104 across multiple sensors (e.g., 116, 118 and 120) thereby preserving the user context. As will be appreciated by one skilled in the art, the unique customer identity signature (UCIS) 128 is maintained as an anonymous parameter and may not carry any personally identifiable information about any customer 104.

The processor 106 is further configured to track various activities of the customer 104 within the retail store 102 using the UCIS 128 of the respective customer (e.g., 104). For example, the processor 106 is configured to track customer activities such as movement of the customer 104 across various locations in the retail store 102. In an embodiment, the processor 106 may be configured to track activities such as entry and exit of the customer 104 in the retail store 102 that may be monitored by matching of the UCIS 128 of the customers 104 at the store entrance.

In one example, the area of the retail store 102 may be divided into various zones and each zone may be monitored by a set of sensors (e.g., 116, 118 and 120). The movement of the customer 104 across the store zones is tracked by identifying the movement across the adjacent zones within a single sensor field of view. In a further embodiment, in case the movement of the customer 104 is detected across the zones of the retail store 102 by the sensors (e.g., 116, 118 and 120), the UCIS 128 is detected and shared across the sensors (e.g., 116, 118 and 120) to build a customer track. For a multiple sensor installation zone, the customer detection and tracking may be determined by combination of the sensor data received from multiple sensors (e.g., 116, 118 and 120) located in the respective zone. The multiple sensors (e.g., 116, 118 and 120) located across the sore 102 may be of the same type or may be different.

The offline clickstream generator 126 is configured to generate an offline clickstream for each of the one or more customers (e.g. 104) using the unique customer identity signature UCIS 128 as the respective customer (e.g. 104) moves across the retail store 102. In an embodiment, the offline clickstream of each of the customer (e.g. 104) is generated using NFG tags, RFID tags, Bluetooth tags, or combinations thereof received from the one or more sensors (e.g., 116, 118 and 120). In another embodiment, at least one of customer-to-customer and customer-to-product interactions are tracked using the generated offline clickstream as each customer 104 navigates through the retail store 102. In this example embodiment, the customer-to-customer interactions are identified based on visual indications such as gestures, facial and voice sentiment analysis. Similarly, the customer-to-product interactions may include picking of certain product from the shelf or placing the product on the shelf by the customer 104, product conversion rate and the like. In the above example embodiment, the customer 104 may be tracked across time and space through various sensors (e.g., 116, 118 and 120) and the customer behavior patterns and intent of purchase are captured within a retail store 102.

The data analytics cloud platform 110 is communicatively coupled to the processor 106 and is configured to analyze the offline clickstream of each of the one or more customers (e.g., 104) to generate one or more of customer engagement and retail insights. In one embodiment, the customer engagement and retail insights include store optimization, staff positioning within the retail store, customer recommendations, visual merchandizing, marketing effectiveness, or combinations thereof.

In another embodiment, the data analytics cloud platform 110 is configured to generate instore data such as customer footfall count, store peel-off rate, marketing and campaign effectiveness, trial room conversions, or combinations thereof. Other instore data may include staff count elimination, store group count, average dwell time, and traffic trend, among others. In addition, the data analytics cloud platform 110 is configured to generate staff planning recommendations and is configured to monitor the effectiveness of the interactions based on audio and video analysis of the customer sentiment. In some embodiments, the data analytics cloud platform 110 may receive data from multiple stores of the same brand and may analyze such data to generate retail insights for the respective brand.

The personalized engagement module 112 is communicatively coupled to the data analytics cloud platform 110. In this embodiment, the personalized engagement module 112 is configured to facilitate direct and/or in-direct engagement with the customers (e.g. 104) based upon the customer engagement and retail insights generated from the data analytics cloud platform 110. In an embodiment, the personalized engagement module 112 is configured to facilitate customer engagement with the customers (e.g. 104) via a plurality of communication channels such as generally represented by reference numerals 132, 134 and 136. Such communication channels 132, 134, and 136 may include email, SMS, mobile application, voice call, and the like.

In another embodiment, the personalized engagement module 112 is configured to provide personalized notifications and recommendations to each of the customers (e.g. 104). In addition, real-time customer interaction guidelines are generated for the store staff wherein they may receive real-time inputs from the in-store customer tracking and engagement system 100 that can facilitate necessary actions to establish long-term relationships with the customers 104 based on their preferences, behaviors and purchases, thus, adding a layer of personal touch to the shopping experience. The customer interaction guideline inputs generated by the in-store customer tracking and engagement system 100 for the store staff may be delivered to the staff through a mobile app, an automated and interactive voice response system or a real-time message sent through SMS, email, or combinations thereof. Other communication channels may be envisaged.

It may be noted that along with the customer identification data 122, the memory 108 may be used to store product information, in store data, customer and retail insights and the offline clickstream generated for each customer 104. In addition, memory 108 may be used to store customer behavior, transaction history, patterns and inventory details.

The output module 114 is configured to display data such as the customer and retail insights, customer footfall count, store peel-off rate, data reflecting trial room conversions, marketing and campaign effectiveness, visual merchandizing, customer recommendations, or combinations thereof. The computer readable instructions executed by the processor 106 are used to carry out the functionalities of each of the above-identified modules.

It should be noted that though the above description is with reference to a retail store, the customer tracking and engagement system 100 may be used in a variety of environments such as commercial establishments, hotels, offices, and so forth to facilitate real-time detection and tracking of users/customers.

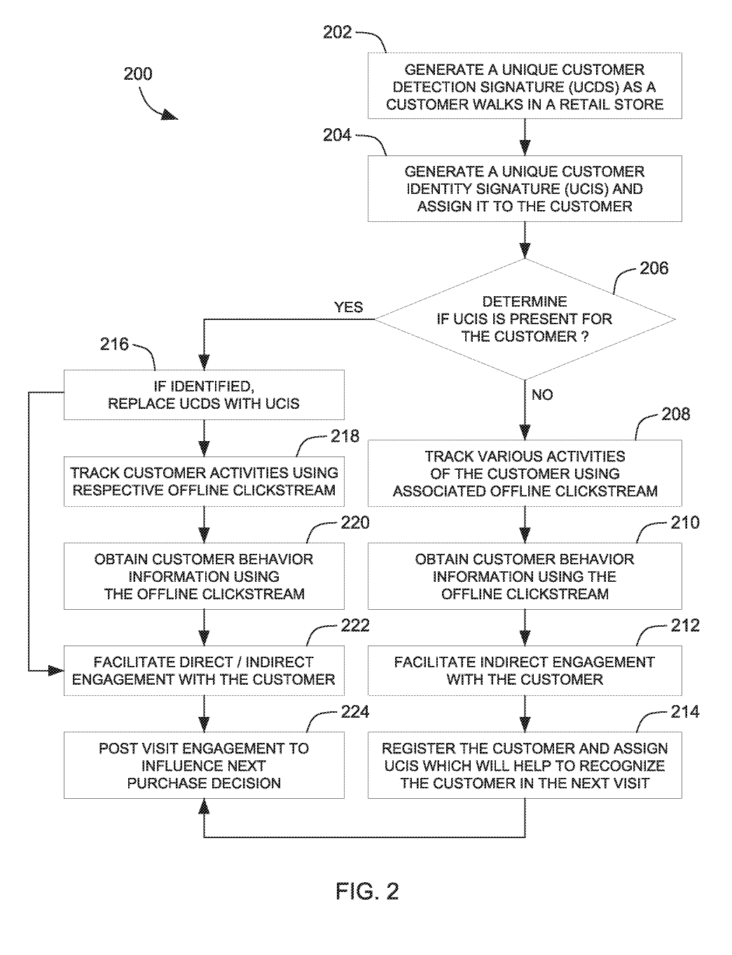

FIG. 2 is a flow chart illustrating a process 200 for identification and tracking customers and their behavior in a retail store using the instore customer tracking and engagement system 100 of FIG. 1, according to aspects of the present invention.

At block 202, a unique signature or pattern such as a unique customer detection signature (UCDS) 130 is generated for a customer (e.g., 104) as the customer 104 enters a retail store 102. In this embodiment, one or more sensors (e.g., 116, 118 and 120) installed in the retail store 102 detect the presence of the customer (e.g., 104) as a new visitor. In some embodiments, customer identification data 122 of one or more customers (e.g., 104) visiting the retail store 102 is obtained using the one or more sensors (e.g., 116, 118 and 120) located in the retail store 102. In an embodiment, the customer identification data 122 may include a mobile number, a photograph or other information like social media or mobile app information for identification of the one or more customers (e.g., 104). In addition, the customer identification data 122 is used to determine demographics, colour of the clothes, pattern of clothes, visual attributes, or combinations thereof of each customer (e.g., 104).

At block 204, as the customer 104 enters the retail store 102, a unique customer identity signature (UCIS) 128 is generated for the customer 104 based upon the customer identification data 122. Spatial and temporal coordinates along with other attributes such as color or pattern of the clothes, demographics visual attributes and the like, associated with each customer, are used to generate the unique customer identity signature (UCIS) 128. In an embodiment, the UCIS 128 assigned to the customer 104 is used to track the customer activity across the retail store 102. In this embodiment, the customer activity is tracked using an offline clickstream generated using the UCIS 128 as the customer 104 moves across the store.

At block 206, it is verified if the UCIS 128 is available for the customer 104. If it is determined that the UCIS 128 is not available, then the activities of the customer 104 within the retail store 102 are tracked through associated offline clickstream (block 208). Further, the customer behavior information is obtained using the offline clickstream (block 210) to facilitate indirect engagement with customers (e.g., 104), as illustrated at block 212. Moreover, at block 214, the customer 104 is registered and assigned with an associated UCIS (e.g., 128) that will help to recognize the customer 104 on his/her next visit to the retail store 102.

Further, as illustrated at block 216, if it is determined that the UCIS 128 is available, then the UCDS 130 is replaced with the UCIS 128. At block 218, the customer activities are tracked through their respective offline clickstream associated with the UCIS. At block 220, the customer behavior information is obtained using the offline clickstream and direct/indirect engagement is facilitated with customers (block 222). Moreover, post visit engagement is utilized to influence next purchase decision of the customer 104 at block 224.

In some examples, the spatial and temporal coordinates along with other attributes of the customer (e.g., 104) such as color or pattern of the clothes associated with each customer are used to generate a unique customer signature such as the UCIS 128. In one example, the behavior of the customers 104 obtained using the offline clickstream is analyzed and personalized retailing insights are generated. In one example, customized offers are generated that are targeted for the customers 104 based on their behavior.

As discussed above, direct and/or in-direct engagement with the customers through various communication channels is facilitated using the system 100. Such communication channels may include email, SMS, mobile application, voice call or the like. In an embodiment, a personalized notification and recommendations is provided to the customer (e.g. 104). In addition, various clienteling guidelines are generated to establish long-term relationships with the customers based on their preferences, behaviors and purchases.

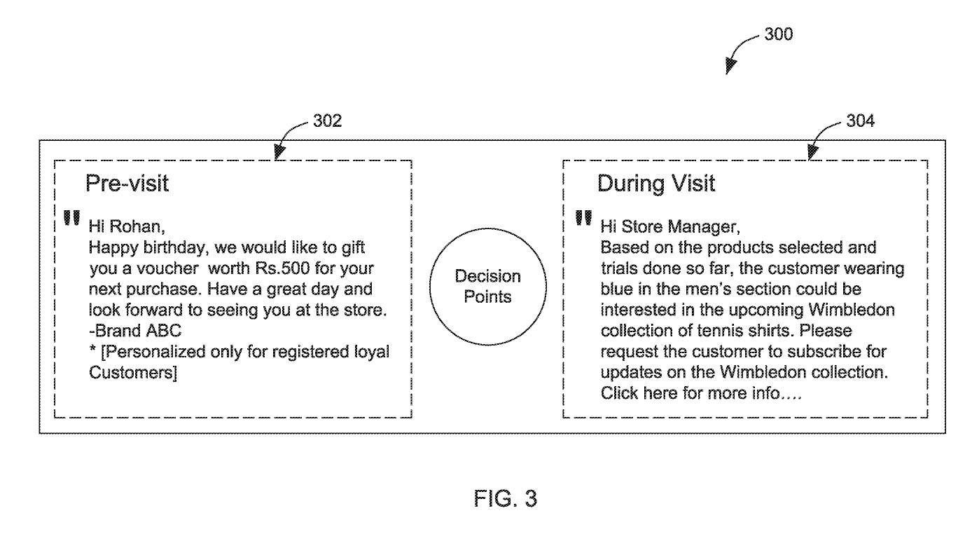

FIG. 3 illustrates example real-time messages 300 sent to one or more customers (e.g. 104) and a store manager of the retail store 102 using the system 100 of FIG. 1, implemented according to the aspects of the present technique. As described before, the data analytics cloud platform 110 of the system 100 is configured to analyze the offline clickstream of each of the one or more customers (e.g., 104) and to generate one or more of customer engagement and retail insights such as personalized offers for the customers based on their shopping trends and other demographic information. In the illustrated embodiment, messages received by a customer 104 before a visit to the retail store 102 and by a store manager in real-time during customers visit are represented by reference numerals 302 and 304. As will be appreciated by one skilled in the art, such interactions trigger decision points in shopping lifecycle of the customer (e.g., 104).

In this illustrated example, the pre-visit communication message sent to the customer (e.g., 104) is a personalized message to the customer (e.g., 104) where the customer 104 is presented with an offer for his next purchase. However, it may be noted that such personalized interactions may be generated for loyal registered customers eligible for such personalized offers. In this example, the message 302 may be sent to the customer 104 via email, an SMS or a voice call.

The message 304 is sent to a store manager of the retail store 102 during a customer's (e.g., 104) visit to the retail store 102. In this example, the content of the message 304 may be designed based on customer's behavior (current and past). As can be seen, the message indicates the store manager of products that may be of the customers interest and the store manager can use such guidelines to enhance the customers shopping experience within the retail store, as well as increasing the chances of selling certain products of interest to the customer 104. This may be achieved by providing retail store staff with relevant and real-time customer interaction guidelines.

In an embodiment, such real-time customer interaction guidelines are designed based on customer behavior such as time spent in a particular section of the retail store 102 and products seen, trials of certain items, demographics of the customer, fashion profiling of clothes and the like. Here for example, the staff of the retail store 102 is provided with relevant real-time guidelines based on the customer's behavior such as trials done so far and fashion profiling of the clothes he is wearing. It may be noted that such decision points help target the customers (e.g., 104) of the retail store 102 in a more meaningful, consistent and personalized manner.

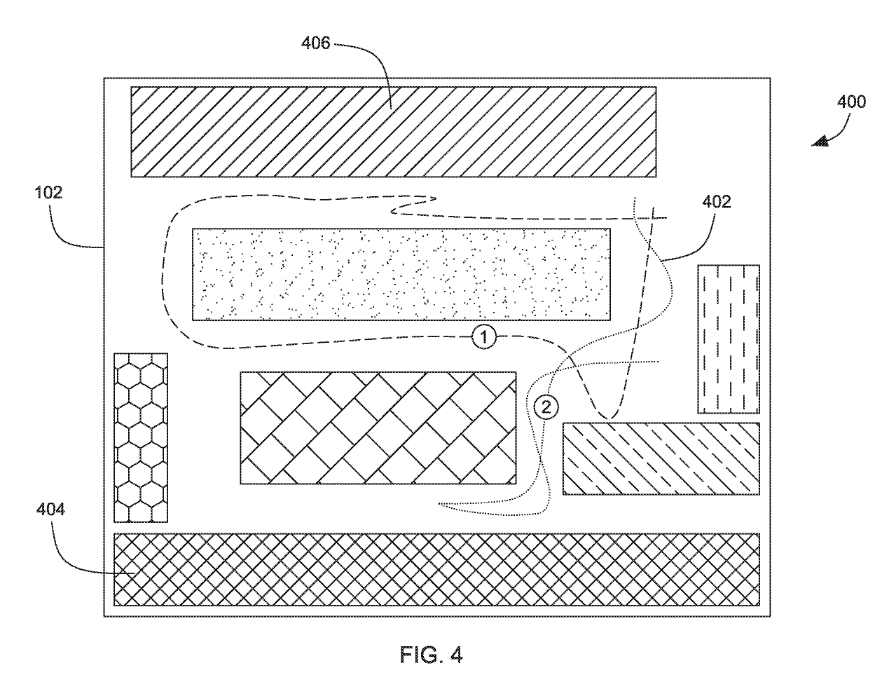

FIG. 4 is an example foot fall map 400 illustrating footfall of customers in a store generated using the system 100 of FIG. 1. In an embodiment, a real-time imaging using the sensors (e.g., 116, 118 and 120) of instore customer tracking and engagement system 100 is performed across the retail store 102. The real-time imaging tracks the customer movement and converts the captured information into a variety of reports such as the foot fall map 400. The foot fall map 400 utilizes customer footfall data obtained using the sensors (e.g., 116, 118 and 120) and represents number of customers present in different zones of the retail store 102. In an example embodiment, the real-time images from the camera and other devices are used to analyze the customer movement within various zones of the retail store 102. In some embodiments, heat maps with different colors or shades corresponding to associated foot traffic in that particular zone during a particular time period may be generated.

In this example, customer journey trackers such as represented by reference numeral 402 indicative of the customer's journey across various zones such as 404 and 406 is used to build offline clickstreams. In operation, the system 100 is configured to monitor every customer's (e.g., 104) traversal path in the retail store 102 and assigns an ID to the journey as marked by #1 and #2 in the foot fall map 400. These tracks or clickstream carry detailed information about the customer's in-store behavior including parameters such as time spent in the store, section dwell time, trial room visits and intent capturing and section/category a customer is interested in, among others. In this embodiment, the system 100 utilizes this information to generate real-time customer engagement and recommendations to facilitate personalized direct/indirect interaction with each customer 104 in the retail store 102.

Moreover, such analytics data is further used to understand the store conversion rates for increasing the revenue. For example, data related to movement of customers in a retail store (e.g., 102) is useful in optimizing the store layout and strategize about where to place popular vs. unpopular and expensive vs. cheap merchandise. It may be noted that various other types of analytical data such as retail planogram and merchandise heat map, touch heat map may be generated and used for developing retail strategies.

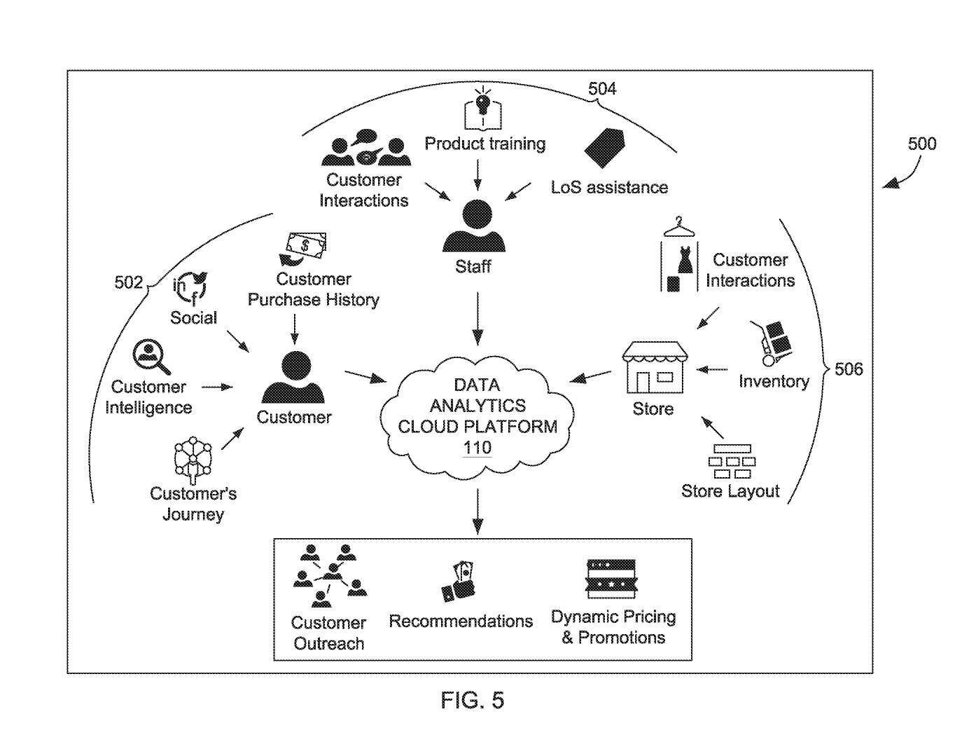

FIG. 5 illustrates a block diagram 500 illustrating generation of personalized recommendations using the data analytics cloud platform 110 of the system of FIG. 1. The data analytics cloud platform 110 utilizes customer inputs (502) regarding customer's behavior from a variety of sources and generates unified predictive recommendations based on such inputs. In this embodiment, contextual insights and recommendations are generated based on customer's journey, customer purchase history, and the like. The data analytics cloud platform 110 receives customer data such as from social networking sites, customer purchase history, customer behavior within a retail store (e.g., 102) and so forth. The data analytics cloud platform 110 also receives information (504) regarding staff of the store such as customers interactions with the store staff, product training information and so forth. In addition, the data analytics cloud platform 110 receives store information (506) regarding details of the particular store such as inventory, store layout, among others. The data analytics cloud platform 110 analyzes such data and generates personalized and relevant recommendations for the customers as well as the store staff.

In this example. such personalized and relevant recommendations and notifications are sent to the customers through a variety of communication channels. In some examples, direct and/or in-direct engagement with the customers through various communication channels is achieved. Such communication channels may include email, SMS, mobile application, voice call or the like. In addition, various clienteling guidelines are generated to establish long-term relationships with the customers based on their preferences, behaviors and purchases. In a further embodiment, item tracking, cart creation, payment and seamless checkout may be achieved.

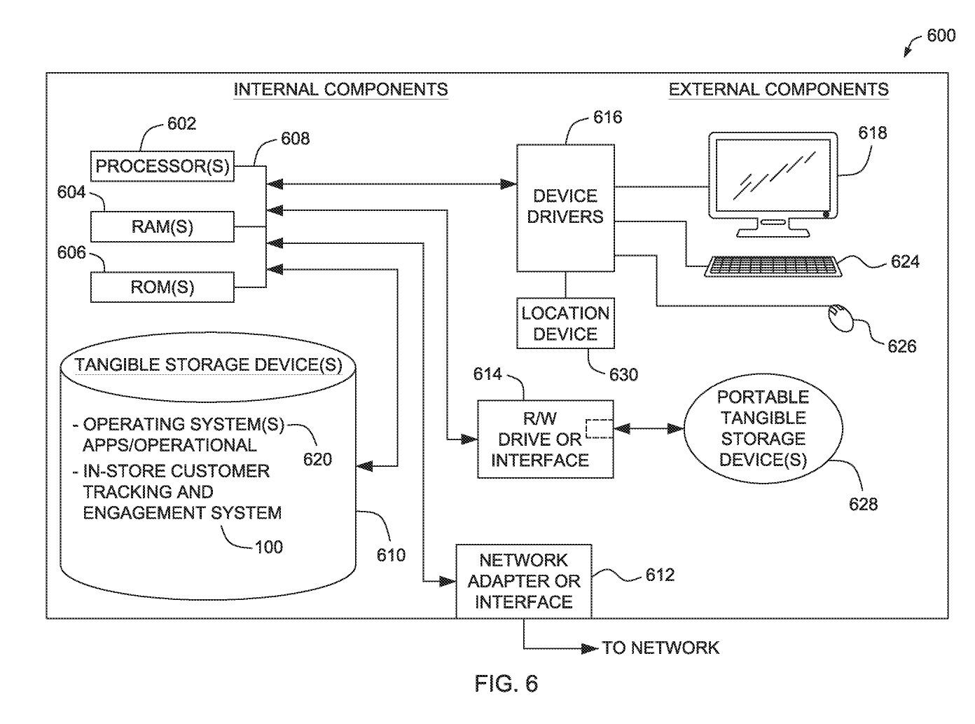

The modules of the in-store customer tracking and engagement system 100 described herein are implemented in computing devices. One example of a computing device 600 is described below in FIG. 6. The computing device includes one or more processor 602, one or more computer-readable RAMs 604 and one or more computer-readable ROMs 606 on one or more buses 608. Further, computing device 600 includes a tangible storage device 610 that may be used to execute operating systems 620 and the in-store customer tracking and engagement system 100. The various modules of the in-store customer tracking and engagement system including a processor 106, a memory 108, a data analytics cloud platform 110, a personalized engagement module 112 and an output module 114, may be stored in tangible storage device 610. Both, the operating system 620 and the system 100 are executed by processor 602 via one or more respective RAMs 604 (which typically include cache memory). The execution of the operating system 620 and/or the system 100 by the processor 602, configures the processor 602 as a special purpose processor configured to carry out the functionalities of the operation system 620 and/or the in-store customer tracking and engagement system 100, as described above.

Examples of storage devices 610 include semiconductor storage devices such as ROM 606, EPROM, flash memory or any other computer-readable tangible storage device that may store a computer program and digital information.

Computing device also includes a R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless Wi-Fi interface cards, or 3G or 4G wireless interface cards or other wired or wireless communication links are also included in computing device.

In one example embodiment, the in-store customer tracking and engagement system 100 which includes a processor 106, a memory 108, a data analytics cloud platform 110, a personalized engagement module 112 and an output module 114, may be stored in tangible storage device 610 and may be downloaded from an external computer via a network (for example, the Internet, a local area network or other, wide area network) and network adapter or interface 612.

Computing device further includes device drivers 616 to interface with input and output devices. The input and output devices may include a computer display monitor 618, a keyboard 624, a keypad, a touch screen, a computer mouse 626, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The afore mentioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

1. An instore customer tracking and engagement system, the system comprising:
a memory having computer-readable instructions stored therein;
a processor configured to:
access customer identification data of one or more customers visiting a retail store;
determine a unique customer identity signature (UCIS) of each of the one or more customers based upon the customer identification data of the respective customer;
track the activity of each of the customers within the retail store using the unique customer identity signature of the respective customer;
generate an offline clickstream for each of the one or more customers using the unique customer identity signature as the respective customer moves across the retail store;
a data analytics cloud platform communicatively coupled to processor, wherein the data analytics cloud platform is configured to analyze the offline clickstream of each of the one or more customers and to generate one or more of customer engagement and retail insights; and
a personalized engagement module communicatively coupled to the data analytics cloud platform and configured to facilitate direct and/or in-direct engagement with the customers based upon the customer engagement and retail insights.

2. The instore customer tracking and engagement system of claim 1, wherein the processor is configured to receive the customer identification data from one or more sensors located within the retail store.

3. The instore customer tracking and engagement system of claim 2, wherein the processor is configured to receive demographics, colour of the clothes, pattern of clothes, visual attributes, or combinations thereof of each customer.

4. The instore customer tracking and engagement system of claim 2, wherein the one or more sensors are configured to:
detect presence of one or more customers in the retail store; and
obtain a mobile number, a photograph, social media information, mobile app information, or combinations thereof of each of the one or more customers.

5. The instore customer tracking and engagement system of claim 2, wherein the one or more sensors comprise a visible light camera, an infrared sensor, a thermal sensor, a pressure sensor, a microphone, an antenna, or combinations thereof.

6. The instore customer tracking and engagement system of claim 1, wherein the processor is further configured to:
generate a unique customer detection signature [UCDS] for each customer as the customer enters the retail store;
determine if the unique customer identity signature (UCIS) is available for the respective customer;
track activities of the customer using the offline clickstream of the customer; and
generate the unique customer identity signature (UCIS) for the customer if the UCIS is not available for the respective customer.

7. The instore customer tracking and engagement system of claim 1, wherein the processor is further configured to execute the computer-readable instructions to generate the unique customer identity signature (UCIS) for each of customer, in accordance with the relationship: UCIS=f(unique attributes of the customer, location, time); wherein the unique customer identity signature (UCIS) is a function of the attributes of the customer, the location of customer within the retail store and time.

8. The instore customer tracking and engagement system of claim 7, wherein the processor is further configured to:
generate the offline clickstream of each of the customer using NFG tags, RFID tags, Bluetooth tags, or combinations thereof received from the one or more sensors; and
track at least one of customer-to-customer and customer-to-product interactions using the generated offline clickstream as each customer navigates through the retail store.

9. The instore customer tracking and engagement system of claim 1, wherein the data analytics cloud platform is further configured to execute the computer-readable instructions to generate the customer and retail insights related to store optimization, staff positioning within the retail store, customer recommendations, visual merchandizing, marketing effectiveness, or combinations thereof.

10. The instore customer tracking and engagement system of claim 1, wherein the data analytics cloud platform is further configured to generate instore data, wherein the instore data comprises customer footfall count, store peel-off rate, marketing and campaign effectiveness, trial room conversions, or combinations thereof.

11. The instore customer tracking and engagement system of claim 1, wherein the personalized engagement module is further configured to facilitate direct and/or in-direct engagement with the customers via a plurality of communication channels, wherein the communication channels comprise email, SMS, mobile application, voice call, or combinations thereof.

12. The instore customer tracking and engagement system of claim 11, wherein the personalized engagement module is further configured to transmit real-time customer interaction guidelines for the store staff, wherein the real-time customer interaction guidelines are delivered to the staff via a mobile app, an automated and interactive voice response system or a real-time message through SMS, email, or combinations thereof.

13. A computer-implemented method for tracking and engaging with the customers, the method comprising:
accessing customer identification data of one or more customers visiting a retail store;
determining a unique customer identity signature (UCIS) of each of the one or more customers, wherein the UCIS is based upon the customer identification data of the respective customer;
tracking the activity of each of the customers within the retail store using the unique customer identity signature (UCIS) of the respective customer;
generating an offline clickstream for each of the one or more customers using the unique customer identity signature (UCIS) as the respective customer moves across the store;
analyzing the offline clickstream of each of the one or more customers; and
generating one or more of customer engagement and retail insights for facilitating direct and/or in-direct engagement with the customers.

14. The computer implemented method of claim 13, further comprising receiving the customer identification data from one or more sensors located within the retail store.

15. The computer implemented method of claim 13, further comprising:
generating a unique customer detection signature [UCDS] for each customer as the customer enters the retail store;
determining if the unique customer identity signature (UCIS) is available for the respective customer;
tracking activities of the customer using the offline clickstream of the customer; and
generating the unique customer identity signature (UCIS) for the customer if the UCIS is not available for the respective customer.

16. The computer-implemented method of claim 13, further comprising generating the customer and retail insights related to store optimization, staff positioning within the retail store, visual merchandizing, marketing effectiveness, or combinations thereof.

17. An instore customer tracking and engagement system, the system comprising:
a memory having computer-readable instructions stored therein;
a processor configured to:
access customer identification data of one or more customers visiting a retail store;
generate a unique customer detection signature [UCDS] for each of the one or more customers as the customer enters the retail store;
determine if a unique customer identity signature (UCIS) is associated with each of the one or more customer;
generate the unique customer identity signature (UCIS) for the customers visiting the retail store for the first time, wherein the unique customer identity signature (UCIS) is a function of the attributes of the customer and the location of customer within the retail store and time;
track the activity of each of the customers within the retail store using the unique customer identity signature (UCIS) of the respective customer, wherein the activity comprises at least one of customer-to-customer and customer-to-product interactions;
generate an offline clickstream for each of the one or more customers using the unique customer identity signature as the respective customer moves across the retail store; and
a data analytics cloud platform communicatively coupled to processor, wherein the data analytics cloud platform is configured to analyze the offline clickstream of each of the one or more customers and to generate one or more of customer engagement and retail insights.

18. The instore customer tracking and engagement system of claim 17, wherein the system further comprises a personalized engagement module configured to facilitate direct and/or in-direct engagement with the customers based upon the customer engagement and retail insights.

19. The instore customer tracking and engagement system of claim 17, wherein the processor is configured to receive the customer identification data from one or more sensors located within the store, wherein the one or more sensors comprise a visible light camera, an infrared sensor, a thermal sensor, a pressure sensor, a microphone, an antenna, or combinations thereof.

20. The instore customer tracking and engagement system of claim 17, wherein the data analytics cloud platform is further configured to execute the computer-readable instructions to generate the customer and retail insights related to retail store optimization, staff positioning within the retail store, visual merchandizing, marketing effectiveness, or combinations thereof.
